(19) United States
(12) Patent Application Publication
(10) Pub. No.: US 2026/0030267 A1
(43) Pub. Date: Jan. 29, 2026

(54) DETERMINING A RELATIONSHIP BETWEEN AN OBJECT AND A HUMAN-PROVIDED INDICATION ASSOCIATED WITH THE OBJECT

(71) Applicant: Toyota Jidosha Kabushiki Kaisha, Toyota-shi Aichi-ken (JP)

(72) Inventors: Hans-Peter Loeb, Menlo Park, CA (US); Jimmy Chiu, San Jose, CA (US); Tyler La Monda, Fairfield, CA (US)

(21) Appl. No.: 18/787,459

(22) Filed: Jul. 29, 2024

(51) Int. Cl. G06F 16/28; G06F 3/01; G06T 7/20; G06T 7/70; G06V 20/56; G06V 20/59

(52) U.S. Cl. CPC G06F 16/288; G06F 3/013; G06F 3/017; G06T 7/20; G06T 7/70; G06V 20/56; G06V 20/59; G06T 2207/30168

(57) ABSTRACT

A system for determining a relationship between an object and a human-provided indication associated with the object can include a processor and a memory. The memory can store an image reception module, a recording reception module, a relationship determination module, and a database query module. The image reception module can receive an image that includes a representation of the object, but lacks a representation of the human-provided indication associated with the object. The recording reception module can receive a recording that includes the representation of the human-provided indication, but lacks the representation of the object. The relationship determination module can determine an existence of the relationship between the object and the human-provided indication. The database query module can cause, based on a determination of the existence of the relationship, a database to produce, in response to a query about a subject of the human-provided indication, information about the object.

### TECHNICAL FIELD

The disclosed technologies are directed to determining a relationship between an object and a human-provided indication associated with the object.

### BACKGROUND

Development of advanced driver-assistance systems (ADAS) technologies have caused many vehicles to include forward-facing cameras. Forward-facing cameras have been required, by the United States Department of Transportation, to be installed on all production vehicles since 2018. Forward-facing cameras can be used, for example, to support such ADAS technologies as forward collision warning systems, lane departure warning systems, lane centering systems, lane keeping assist systems, adaptive cruise control systems, traffic sign recognition systems, and the like. Additionally, some vehicles have been configured so that images from forward-facing cameras can be presented on one or more displays installed on the vehicles. Having an ability to present images from a forward-facing camera on one or more displays installed on a vehicle can be used, for example, to support ADAS technologies, record evidence of traffic collisions, improve visibility for an operator of the vehicle (e.g., when the forward-facing camera provides the operator with an extended view of one or more objects in front of the vehicle), and the like.

### SUMMARY

In an embodiment, a system for determining a relationship between an object and a human-provided indication associated with the object can include a processor and a memory. The memory can store an image reception module, a recording reception module, a relationship determination module, and a database query module. The image reception module can include instructions that, when executed by the processor, cause the processor to receive an image that includes a representation of the object, but lacks a representation of the human-provided indication associated with the object. The recording reception module can include instructions that, when executed by the processor, cause the processor to receive a recording that includes the representation of the human-provided indication, but lacks the representation of the object. The relationship determination module can include instructions that, when executed by the processor, cause the processor to determine an existence of the relationship between the object and the human-provided indication. The database query module can include instructions that, when executed by the processor, cause the processor to cause, based on a determination of the existence of the relationship, a database to produce, in response to a query about a subject of the human-provided indication, information about the object.

In another embodiment, a method for determining a relationship between an object and a human-provided indication associated with the object can include receiving, by a processor, an image that includes a representation of the object, but lacks a representation of the human-provided indication associated with the object. The method can include receiving, by the processor, a recording that includes the representation of the human-provided indication, but lacks the representation of the object. The method can include determining, by the processor, an existence of the relationship between the object and the human-provided indication. The method can include causing, by the processor and based on a determination of the existence of the relationship, a database to produce, in response to a query about a subject of the human-provided indication, information about the object.

In another embodiment, a non-transitory computer-readable medium for determining a relationship between an object and a human-provided indication associated with the object can include instructions that, when executed by one or more processors, cause the one or more processors to receive an image that includes a representation of the object, but lacks a representation of the human-provided indication associated with the object. The non-transitory computer-readable medium can include instructions that, when executed by one or more processors, cause the one or more processors to receive a recording that includes the representation of the human-provided indication, but lacks the representation of the object. The non-transitory computer-readable medium can include instructions that, when executed by one or more processors, cause the one or more processors to determine an existence of the relationship between the object and the human-provided indication. The non-transitory computer-readable medium can include instructions that, when executed by one or more processors, cause the one or more processors to cause, based on a determination of the existence of the relationship, a database to produce, in response to a query about a subject of the human-provided indication, information about the object.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 includes a diagram that illustrates an example of an environment, at an earlier time, for determining a relationship between an object and a human-provided indication associated with the object, according to the disclosed technologies.

FIG. 2 includes a diagram that illustrates the example of the environment, at a later time, for determining the relationship between the object and the human-provided indication associated with the object, according to the disclosed technologies.

FIG. 3 is a block diagram that illustrates an example of a system for determining a relationship between an object and a human-provided indication associated with the object, according to the disclosed technologies.

FIGS. 4A and 4B include a flow diagram that illustrates an example of a method that is associated with determining a relationship between an object and a human-provided indication associated with the object, according to the disclosed technologies.

FIG. 5 includes a block diagram that illustrates an example of elements disposed on a vehicle, according to the disclosed technologies.

### DETAILED DESCRIPTION

The disclosed technologies are directed to determining a relationship between an object and a human-provided indication associated with the object. The disclosed technologies can improve database technologies because an existence of the relationship between the object and the human-provided indication associated with the object can be determined without a need to: (1) predetermine the existence of the relationship in a schema of the database or (2) use textual information (e.g., via a keyboard interface, speech-to-text technology, or the like).

An image that includes a representation of the object, but lacks a representation of the human-provided indication associated with the object can be received. For example, the human-provided indication can include one or more of a hand gesture, a gaze, an audible comment, or the like. For example, the image can have been produced by a camera. For example, at a time of a production of the image, the object can have been within a field of view of the camera, but the human-provided indication can have been one or more of outside of the field of view the camera or otherwise imperceptible by the camera (e.g., the human-provided indication can have been an audible comment). A recording that includes a representation of the human-provided indication, but lacks a representation of the object can be received.

The existence of the relationship between the object and the human-provided indication can be determined. For example: (1) the image can have been produced at a first time by the camera, (2) the recording can have been produced at a second time, (3) the human-provided indication can signify a specific direction, (4) a location of the object at the second time can be in the specific direction from a human that produced the human-provided indication, and (5) based on: (a) information about the location of the object at the second time and (b) information about a relative motion between the camera and the object between the first time and the second time, a location of the object at the first time can be determined to correspond to the representation of the object included in the image. For example, relationship information, between the object and the human-provided indication, can be stored in a database. The database can be caused to produce, in response to a query about a subject of the human-provided indication, information about the object.

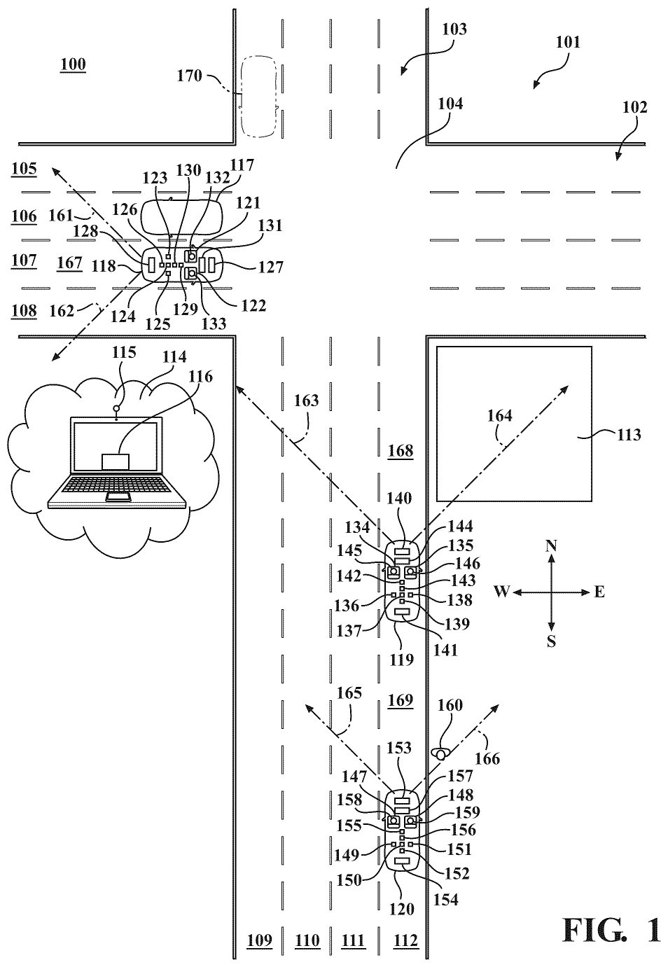

FIG. 1 includes a diagram 100 that illustrates an example of an environment, at an earlier time 101, for determining a relationship between an object and a human-provided indication associated with the object, according to the disclosed technologies. For example, the diagram 100 can include First Street 102 (disposed along a line of latitude) and Avenue A 103 (disposed along a line of longitude). For example, the diagram 100 can include a road junction 104 (e.g., an intersection) of First Street 102 and Avenue A 103. For example, First Street 102 can include a right westbound lane 105, a left westbound lane 106, a left eastbound lane 107, and a right eastbound lane 108. For example, Avenue A 102 can include a right southbound lane 109, a left southbound lane 110, a left northbound lane 111, and a right northbound lane 112. For example, the diagram 100 can include, at a southeast corner of the road junction 104, a bar 113. For example, the diagram 100 can include a cloud computing platform 114. For example, the cloud computing platform 114 can include a communications device 115 and a data storage 116.

For example, the diagram 100 can include a first vehicle 117, a second vehicle 118, a third vehicle 119, and a fourth vehicle 120. For example, the second vehicle 118 can include one or more of a driver's seat 121, a front passenger seat 122, a processor 123, a memory 124, a data storage 125, a communications device 126, a forward-facing camera 127, a rearward-facing camera 128, a cabin view camera 129, a microphone 130, or a display 131. For example, Ascher 132 can be in the driver's seat 121 and Bryce 133 can be in the front passenger seat 122. For example, the third vehicle 119 can include one or more of a driver's seat 134, a front passenger seat 135, a processor 136, a memory 137, a data storage 138, a communications device 139, a forward-facing camera 140, a rearward-facing camera 141, a cabin view camera 142, a microphone 143, or a display 144. For example, Chad 145 can be in the driver's seat 134 and Dylan 146 can be in the front passenger seat 135. For example, the fourth vehicle 120 can include one or more of a driver's seat 147, a front passenger seat 148, a processor 149, a memory 150, a data storage 151, a communications device 152, a forward-facing camera 153, a rearward-facing camera 154, a cabin view camera 155, a microphone 156, or a display 157. For example, Evan 158 can be in the driver's seat 147 and Forrest 159 can be in the front passenger seat 148. For example, the diagram 100 can include a pedestrian 160, Grace Worthington.

For example, the diagram 100 can include a first pair of rays 161 and 162, a second pair of rays 163 and 164, and a third pair of rays 165 and 166. For example, the first pair rays 161 and 162 can define a field of view 167 of the rearward-facing camera 128 of the second vehicle 118. For example, the second pair rays 163 and 164 can define a field of view 168 of the forward-facing camera 140 of the third vehicle 119. For example, the third pair rays 165 and 166 can define a field of view 169 of the forward-facing camera 153 of the fourth vehicle 120.

For example, at the earlier time 101: (1) the first vehicle 117 can be located in the left westbound lane 106 just west of the road junction 104 and moving in a westerly direction, (2) the second vehicle 118 can be located in the left eastbound lane 107 just west of the road junction 104, just south of the first vehicle 117, and moving in an easterly direction, (3) the third vehicle 119 can be located in the right northbound lane 112 about thirty meters south of the road junction 104 and moving in a northerly direction, (4) the fourth vehicle 120 can be located in the right northbound lane 112 about sixty meters south of the road junction 104 and parked, and (5) the pedestrian 160 can be located on a sidewalk east of the right northbound lane 112 about five meters north of the fourth vehicle 120 and moving in a southerly direction. For example, the diagram 100 can include a representation 170, using dashed lines, of a location of the first vehicle 117 at a time prior to the earlier time 101.

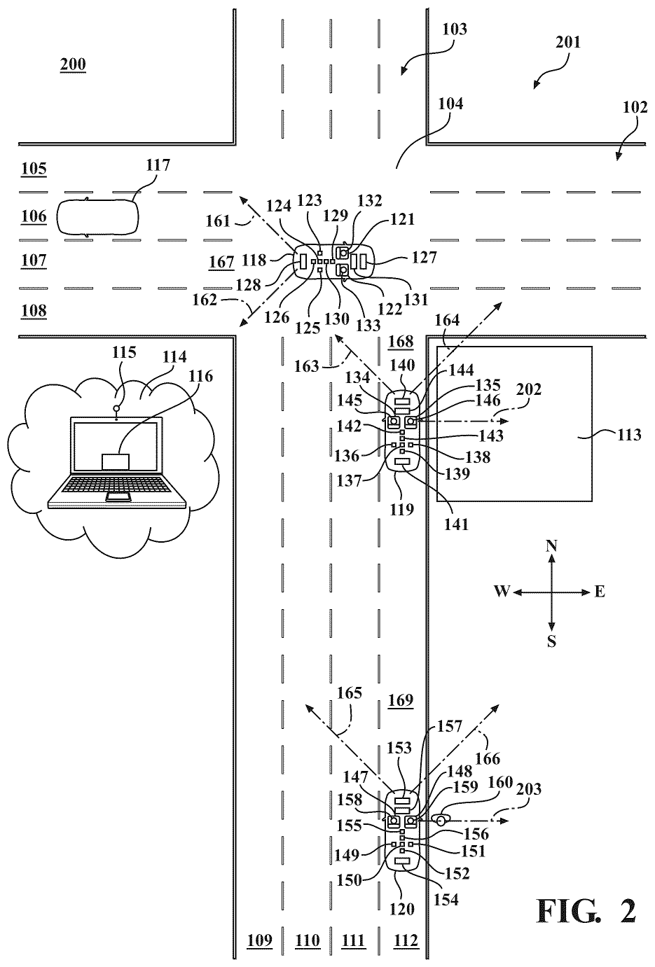

FIG. 2 includes a diagram 200 that illustrates the example of the environment, at a later time 201, for determining the relationship between the object and the human-provided indication associated with the object, according to the disclosed technologies. For example, at the later time 201: (1) the first vehicle 117 can be located in the left westbound lane 106 about sixty meters west of the road junction 104 and moving in a westerly direction, (2) the second vehicle 118 can be located in the left eastbound lane 107 in the road junction 104 and moving in an easterly direction, (3) the third vehicle 119 can be located in the right northbound lane 112 just south of the road junction 104, just west of the bar 113, and moving in a northerly direction, (4) the fourth vehicle 120 can be located in the right northbound lane 112 about sixty meters south of the road junction 104 and parked, and (5) the pedestrian 160 can be located on a sidewalk east of the right northbound lane 112 just east of the fourth vehicle 120 and moving in a southerly direction.

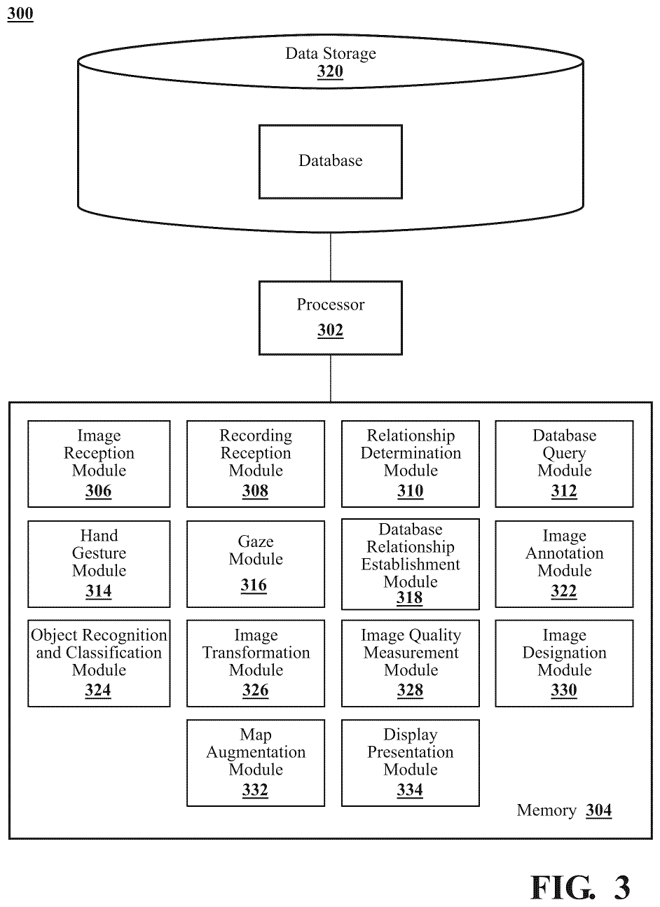

FIG. 3 is a block diagram that illustrates an example of a system 300 for determining a relationship between an object and a human-provided indication associated with the object, according to the disclosed technologies. The system 300 can include, for example, a processor 302 and a memory 304. The memory 304 can be communicably coupled to the processor 302. For example, the memory 304 can store an image reception module 306, a recording reception module 308, a relationship determination module 310, and a database query module 312.

For example, the image reception module 306 can include instructions that function to control the processor 302 to receive an image that includes a representation of the object, but lacks a representation of the human-provided indication associated with the object.

For example, the recording reception module 308 can include instructions that function to control the processor 302 to receive a recording that includes a representation of the human-provided indication, but lacks a representation of the object.

For example, the image can be produced by a camera. For example, the recording can be a recording of sound. Alternatively or additionally, the image can be a first image and the recording can be a second image. For example, the first image can have been produced by a first camera and the second image can have been produced by a second camera. For example, the first camera can be one or more of a forward-facing camera disposed on a vehicle or a rearward-facing camera disposed on the vehicle. For example, the second camera can be a cabin view camera disposed on the vehicle.

For example, the image can have been produced at a first time and the recording can have been produced at a second time. For example, the second time can be after the first time. Alternatively, for example, the second time can be before the first time.

For example, the human-provided indication can include one or more of a hand gesture, a gaze, an audible comment, or the like. For example, one or more of the hand gesture can be a gesture to point in a specific direction, the gaze can be in the specific direction, the audible comment can include information that signifies the specific direction, or the like. Additionally or alternatively, one or more of the hand gesture can signify an opinion of a human that produced the hand gesture, the gaze can signify an opinion of a human that produced the gaze, the audible comment can signify an opinion of a human that produced the audible comment, or the like.

For example, the relationship determination module 310 can include instructions that function to control the processor 302 to determine an existence of the relationship between the object and the human-provided indication. For example: (1) the image can have been produced at a first time by a camera, (2) the recording can have been produced at a second time, (3) the human-provided indication can signify a specific direction, (4) a location of the object at the second time can be in the specific direction from a human that produced the human-provided indication, and (5) the instructions to determine the existence of the relationship can include instructions to determine, based on: (a) information about the location of the object at the second time and (b) information about a relative motion between the camera and the object between the first time and the second time, that a location of the object at the first time corresponds to the representation of the object included in the image. For example, the relative motion can include one or more of a motion of the camera (e.g., included on the vehicle) or a motion of the object.

Additionally, for example, the memory 304 can further store a hand gesture module 314. For example, the hand gesture module 314 can include instructions that function to control the processor 302 to cause, in response to the human-provided indication including a hand gesture, an operation of a hand gesture technique. For example, the hand gesture technique can include: (1) operating gesture recognition technology to determine that the hand gesture is a gesture to point in the specific direction and (2) producing a hand gesture vector in the specific direction. For example, an origin of the hand gesture vector can be a hand arranged to produce the hand gesture.

Alternatively or additionally, for example, the memory 304 can further store a gaze module 316. For example, the gaze module 316 can include instructions that function to control the processor 302 to cause, in response to the human-provided indication including a gaze, an operation of a gaze technique. For example, the gaze technique can include: (1) operating eye point-of-gaze tracking technology to determine that a point of gaze of an eye is in the specific direction and (2) producing a gaze vector in the specific direction. For example, an origin of the gaze vector can be the eye.

With reference to FIGS. 1 and 2, for example, with respect to the third vehicle 119: (1) the image can be a first image, produced at the earlier time 101 by the forward-facing camera 140, that includes a representation of the bar 113, (2) the recording can be a second image, produced at the later time 201 by the cabin view camera 142, that includes a representation of Dylan 146 producing, with his right hand, a hand gesture that is a gesture of a point in a direction of the bar 113, (3) a hand gesture vector 202 can be produced from the right hand of Dylan 146 to the bar 113, and (4) an existence of a relationship between the bar 113 and the hand gesture can be determined by determining, based on: (a) information about the location of the bar 113 at the later time 201 and (b) information about a relative motion between the forward-facing camera 140 and the bar 113 between the earlier time 101 and the later time 201, that a location of the bar 113 at the earlier time 101 corresponds to the representation of the bar 113 included in the first image. Additionally, for example, the second image can include a representation of Dylan 146 producing, with his left hand, a hand gesture that is a thumbs-up gesture that signifies that Dylan 146 has a positive opinion of the bar 113.

For example, with respect to the fourth vehicle 120: (1) the image can be a first image, produced at the earlier time 101 by the forward-facing camera 153, that includes a representation of the pedestrian 160, (2) the recording can be a second image, produced at the later time 201 by the cabin view camera 155, that includes a representation of Forrest 159 gazing in a direction of the pedestrian 160, (3) a gaze vector 203 can be produced from an eye of Forrest 159 to the pedestrian 160, and (4) an existence of a relationship between the pedestrian 160 and the gaze can be determined by determining, based on: (a) information about the location of the pedestrian 160 at the later time 201 and (b) information about a relative motion between the forward-facing camera 153 and the pedestrian 160 between the earlier time 101 and the later time 201, that a location of the pedestrian 160 at the earlier time 101 corresponds to the representation of the pedestrian 160 included in the first image. Additionally, for example, the disclosed technologies can operate emotion recognition technology to determine that the representation of Forrest 159, included in the second image, gazing in the direction of the pedestrian 160 signifies that Forrest 159 has a positive opinion of the pedestrian 160.

For example, with respect to the second vehicle 118: (1) the image can be an image, produced at the later time 201 by the rearward-facing camera 128, that includes a representation of the first vehicle 117, (2) the recording can be a recording of sound, produced at the earlier time 101 by the microphone 130, that includes a representation of Bryce 133 producing an audible comment that includes information that signifies a direction of the first vehicle 117 (e.g., “Look at that car on our right!”), and (3) an existence of a relationship between the first vehicle 117 and the audible comment can be determined by determining, based on: (a) information about the location of the first vehicle 117 at the carlier time 101 and (b) information about a relative motion between the rearward-facing camera 128 and the first vehicle 117 between the earlier time 101 and the later time 201, that a location of the first vehicle 117 at the later time 201 corresponds to the representation of the first vehicle 117 included in the image. Additionally, for example, the disclosed technologies can operate emotion recognition technology to determine that the representation of Bryce 133, included in the recording of sound, producing the audible comment signifies that Bryce 133 has a negative opinion of an operator of the first vehicle 117 (e.g., “That guy is driving like a maniac!”).

Returning to FIG. 3, additionally, for example, the memory 304 can further store a database relationship establishment module 318. For example, the database relationship establishment module 318 can include instructions that function to control the processor 302 to cause relationship information to be stored in a database. For example, the relationship information can include: (1) the recording that includes the representation of the human-provided indication, (2) information about the existence of the relationship between the object and the human-provided indication, and (3) one or more of: (a) the image that includes the representation of the object or (b) another image that includes the representation of the object.

For example, the instructions to cause the relationship information to be stored in the database can include instructions to store the relationship information to the database. For example, the database can be stored in a data storage disposed on a vehicle. For example, the system 300 can further include a data storage 320. The data storage 320 can be communicably coupled to the processor 302. For example, data in the database can be intended to be a private database for use by occupants of the vehicle.

Alternatively or additionally, for example, the instructions to cause the relationship information to be stored in the database can include instructions to: (1) transmit the relationship information to a cloud computing platform and (2) store the relationship information in the database. For example, the database can be stored in a data storage disposed on the cloud computing platform. For example, data in the database can be intended to be a public database for use by individuals authorized to access the cloud computing platform.

Additionally, for example, the memory 304 can further store an image annotation module 322. For example, the image annotation module 322 can include instructions that function to control the processor 302 to cause the one or more of: (1) the image that includes the representation of the object or (2) the other image that includes the representation of the object to be annotated with supplemental information. For example, the supplemental information can be based on one or more of: (1) information signified by the human-provided indication or (2) information produced concurrently with a production of the human-provided indication. For example, the supplemental information can include one or more of information about an identification of the object, information about a location of the object, information about a feature of the object, information about a characteristic of the feature of the object, information about an opinion about the object, or the like.

With reference to FIGS. 1 and 2, for example, with respect to the third vehicle 119, the image that includes the representation of the bar 113 can be annotated with supplemental information. For example, the supplemental information can be based on the hand gesture, produced by the left hand of Dylan 146, that is the thumbs-up gesture that signifies that Dylan 146 has a positive opinion of the bar 113. Additionally, for example, the supplemental information can be based on a recording of sound, produced by the microphone 143 concurrently with a production of the hand gesture, produced by the right hand of Dylan 146, that is the gesture of the point in the direction of the bar 113, that includes a representation of Dylan 146 producing an audible comment that includes one or more of information about a location of the bar 113, information about a feature of the bar 113, information about a characteristic of the feature of the bar 113, information about an opinion of the bar 113, or the like (e.g., “That bar at the corner of First Street and Avenue A with the red double doors is awesome!”).

For example, with respect to the fourth vehicle 120, the image that includes the representation of the pedestrian 160 can be annotated with supplemental information. For example, the supplemental information can be based on a result produced by the emotion recognition technology that signified that Forrest 159 has a positive opinion of the pedestrian 160. Additionally, for example, the supplemental information can be based on a recording of sound, produced by the microphone 156 concurrently with a production of the gaze, produced by Forrest 159 in the direction of the pedestrian 160, that includes a representation of Evan 158 producing an audible comment that includes information about an identification of the pedestrian 160 (e.g., “Isn't that Grace Worthington?”). Additionally, for example, the disclosed technologies can operate facial recognition technology to determine, based on the representation of the pedestrian 160 in the image and the supplemental information, that the identification of the pedestrian 160 is Grace Worthington.

For example, with respect to the second vehicle 118, the image that includes the representation of the first vehicle 117 can be annotated with supplemental information. For example, the supplemental information can be based on a result produced by the emotion recognition technology that signified that Bryce 133 has a negative opinion of the operator of the first vehicle 117. Additionally, for example, the disclosed technologies can operate automatic number-plate recognition (ANPR) technology to read characters on a vehicle registration plate (i.e., a license plate) of the first vehicle 117. Additionally, for example, the supplemental information can be based on a result produced by the ANPR technology that includes the characters on the license plate of the first vehicle 117.

Returning to FIG. 3, alternatively or additionally, for example, the memory 304 can further store an object recognition and classification module 324. For example, the object recognition and classification module 324 can include instructions that function to control the processor 302 to cause the object to be recognized and classified.

Alternatively or additionally, for example, the memory 304 can further store an image transformation module 326. For example, the image transformation module 326 can include instructions that function to control the processor 302 to produce, based on the image that includes the representation of the object, the other image that includes the representation of the object. For example, the other image can be a transformation of the image. For example: (1) the representation of the object in the image can associated with a first point of view of the object and (2) the representation of the object in the other image can be associated with a second point of view of the object. For example, the second point of view can be a point of view of a human that produced the human-provided indication at a time of a production of the recording that includes the representation of the human-provided indication. Alternatively, for example, the second point of view can be a point of view in which a measurement of a recognizability of the object is a greatest value. Alternatively, for example, the second point of view can be a point of view of an image produced by another camera. For example, the other camera can be another camera of the (original) vehicle or a camera of another vehicle. For example, if the other camera is the camera of the other vehicle, then the image produced by the other camera can be communicated to the (original) vehicle.

Alternatively or additionally, for example, the image that includes the representation of the object can be a member of a set of images that include the representation of the object. For example, the camera that produced the image can be configured to produce images at a specific production rate. For example, the specific production rate can be ten hertz. For example, the memory 304 can further store an image quality measurement module 328 and an image designation module 330. For example, the image quality measurement module 328 can include instructions that function to control the processor 302 to determine an image, of the set of images, in which a measurement of an image quality of the object is a greatest value. For example, the image designation module 330 can include instructions that function to control the processor 302 to designate the image, of the set of images, in which the measurement of the image quality of the object is the greatest value, as the other image that includes the representation of the object. For example, the database relationship establishment module 318 can include instructions that function to control the processor 302 to include the other image in the relationship information stored in the database.

Alternatively or additionally, for example, the memory 304 can further store a map augmentation module 332. For example, the map augmentation module 332 can include instructions that function to control the processor 302 to cause useful map information to be included in a map of a vicinity of a location of the object. For example, the useful map information can include one or more of: (1) the one or more of: (a) the image that includes the representation of the object or (b) the other image that includes the representation of the object or (2) supplemental information. For example, the supplemental information can be based on one or more of: (a) information signified by the human-provided indication or (b) information produced concurrently with a production of the human-provided indication.

For example, the database query module 312 can include instructions that function to control the processor 302 to cause, based on a determination of the existence of the relationship, a database to produce, in response to a query about a subject of the human-provided indication, information about the object.

Additionally, for example, the memory 304 can further store a display presentation module 334. For example, the display presentation module 334 can include instructions that function to control the processor 302 to cause the information about the object, produced in response to the query about the subject of the human-provided indication, to be presented on a display. For example, the display can be disposed on a vehicle.

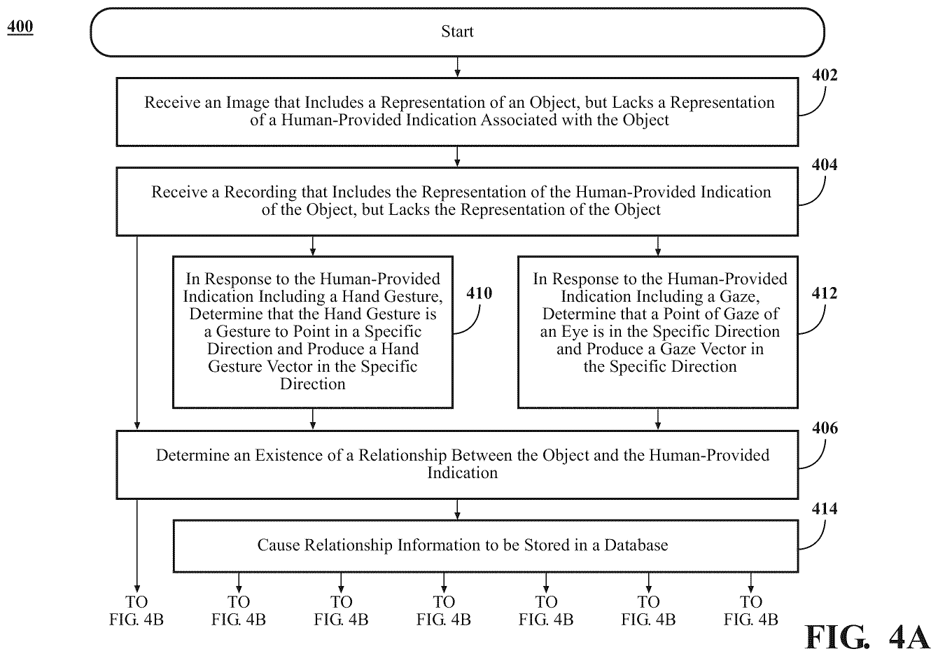

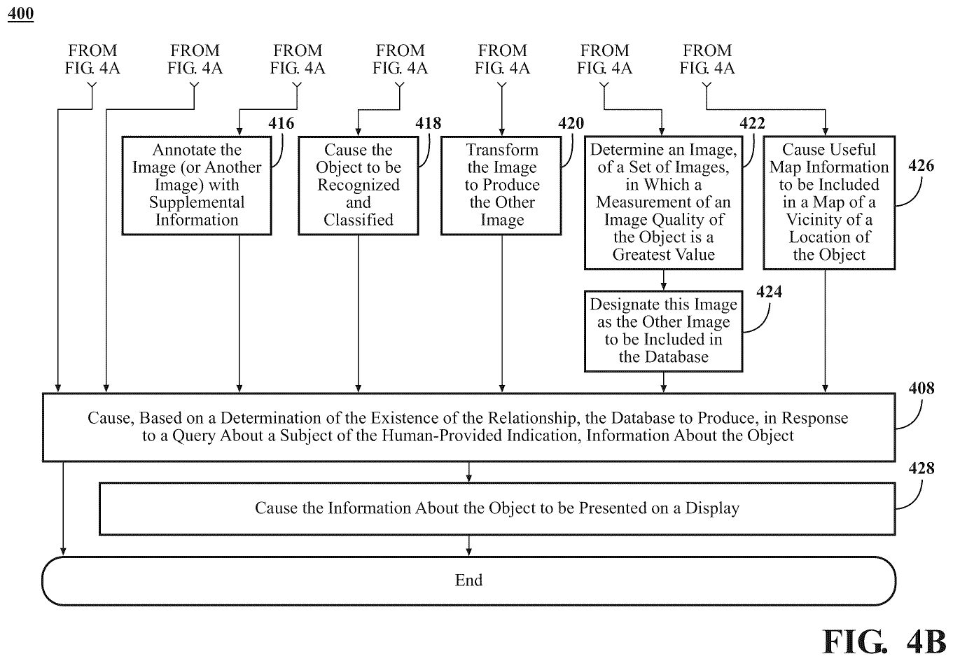

FIGS. 4A and 4B include a flow diagram that illustrates an example of a method 400 that is associated with determining a relationship between an object and a human-provided indication associated with the object, according to the disclosed technologies. Although the method 400 is described in combination with the system 300 illustrated in FIG. 3, one of skill in the art understands, in light of the description herein, that the method 400 is not limited to being implemented by the system 300 illustrated in FIG. 3. Rather, the system 300 illustrated in FIG. 3 is an example of a system that may be used to implement the method 400. Additionally, although the method 400 is illustrated as a generally serial process, various aspects of the method 400 may be able to be executed in parallel.

In FIG. 4A, in the method 400, at an operation 402, for example, the image reception module 306 can receive an image that includes a representation of the object, but lacks a representation of the human-provided indication associated with the object.

At an operation 404, for example, the recording reception module 308 can include instructions that function to control the processor 302 to receive a recording that includes a representation of the human-provided indication, but lacks a representation of the object.

For example, the image can be produced by a camera. For example, the recording can be a recording of sound. Alternatively or additionally, the image can be a first image and the recording can be a second image. For example, the first image can have been produced by a first camera and the second image can have been produced by a second camera. For example, the first camera can be one or more of a forward-facing camera disposed on a vehicle or a rearward-facing camera disposed on the vehicle. For example, the second camera can be a cabin view camera disposed on the vehicle.

For example, the image can have been produced at a first time and the recording can have been produced at a second time. For example, the second time can be after the first time. Alternatively, for example, the second time can be before the first time.

For example, the human-provided indication can include one or more of a hand gesture, a gaze, an audible comment, or the like. For example, one or more of the hand gesture can be a gesture to point in a specific direction, the gaze can be in the specific direction, the audible comment can include information that signifies the specific direction, or the like. Additionally or alternatively, one or more of the hand gesture can signify an opinion of a human that produced the hand gesture, the gaze can signify an opinion of a human that produced the gaze, the audible comment can signify an opinion of a human that produced the audible comment, or the like.

At an operation 406, for example, the relationship determination module 310 can determine an existence of the relationship between the object and the human-provided indication. For example: (1) the image can have been produced at a first time by a camera, (2) the recording can have been produced at a second time, (3) the human-provided indication can signify a specific direction, (4) a location of the object at the second time can be in the specific direction from a human that produced the human-provided indication, and (5) the instructions to determine the existence of the relationship can include instructions to determine, based on: (a) information about the location of the object at the second time and (b) information about a relative motion between the camera and the object between the first time and the second time, that a location of the object at the first time corresponds to the representation of the object included in the image. For example, the relative motion can include one or more of a motion of the camera (e.g., included on the vehicle) or a motion of the object.

In FIG. 4B, in the method 400, at an operation 408, for example, the database query module 312 can cause, based on a determination of the existence of the relationship, a database to produce, in response to a query about a subject of the human-provided indication, information about the object.

In FIG. 4A, in the method 400, additionally, at an operation 410, for example, the hand gesture module 314 can cause, in response to the human-provided indication including a hand gesture, an operation of a hand gesture technique. For example, the hand gesture technique can include: (1) operating gesture recognition technology to determine that the hand gesture is a gesture to point in the specific direction and (2) producing a hand gesture vector in the specific direction. For example, an origin of the hand gesture vector can be a hand arranged to produce the hand gesture.

Alternatively or additionally, at an operation 412, for example, the gaze module 316 can cause, in response to the human-provided indication including a gaze, an operation of a gaze technique. For example, the gaze technique can include: (1) operating eye point-of-gaze tracking technology to determine that a point of gaze of an eye is in the specific direction and (2) producing a gaze vector in the specific direction. For example, an origin of the gaze vector can be the eye.

Additionally, at an operation 414, for example, the database relationship establishment module 318 can cause relationship information to be stored in a database. For example, the relationship information can include: (1) the recording that includes the representation of the human-provided indication, (2) information about the existence of the relationship between the object and the human-provided indication, and (3) one or more of: (a) the image that includes the representation of the object or (b) another image that includes the representation of the object.

At the operation 414, for example, the database relationship establishment module 318 can store the relationship information to the database. For example, the database can be stored in a data storage disposed on a vehicle.

Alternatively or additionally, at the operation 414, for example, the database relationship establishment module 318 can: (1) transmit the relationship information to a cloud computing platform and (2) store the relationship information in the database. For example, the database can be stored in a data storage disposed on the cloud computing platform.

In FIG. 4B, in the method 400, additionally, at an operation 416, for example, the image annotation module 322 can cause the one or more of: (1) the image that includes the representation of the object or (2) the other image that includes the representation of the object to be annotated with supplemental information. For example, the supplemental information can be based on one or more of: (1) information signified by the human-provided indication or (2) information produced concurrently with a production of the human-provided indication. For example, the supplemental information can include one or more of information about an identification of the object, information about a location of the object, information about a feature of the object, information about a characteristic of the feature of the object, information about an opinion about the object, or the like.

Alternatively or additionally, at an operation 418, for example, the object recognition and classification module 324 can cause the object to be recognized and classified.

Alternatively or additionally, at an operation 420, for example, the image transformation module 326 can produce, based on the image that includes the representation of the object, the other image that includes the representation of the object. For example, the other image can be a transformation of the image. For example: (1) the representation of the object in the image can associated with a first point of view of the object and (2) the representation of the object in the other image can be associated with a second point of view of the object. For example, the second point of view can be a point of view of a human that produced the human-provided indication at a time of a production of the recording that includes the representation of the human-provided indication. Alternatively, for example, the second point of view can be a point of view in which a measurement of a recognizability of the object is a greatest value. Alternatively, for example, the second point of view can be a point of view of an image produced by another camera. For example, the other camera can be another camera of the (original) vehicle or a camera of another vehicle. For example, if the other camera is the camera of the other vehicle, then the image produced by the other camera can be communicated to the (original) vehicle.

Alternatively or additionally, for example, the image that includes the representation of the object can be a member of a set of images that include the representation of the object. For example, the camera that produced the image can be configured to produce images at a specific production rate. For example, the specific production rate can be ten hertz. For example, at an operation 422, the image quality measurement module 328 can determine an image, of the set of images, in which a measurement of an image quality of the object is a greatest value. For example, at an operation 424, the image designation module 330 can designate the image, of the set of images, in which the measurement of the image quality of the object is the greatest value, as the other image that includes the representation of the object. For example, the database relationship establishment module 318 can include the other image in the relationship information stored in the database.

Alternatively or additionally, at an operation 426, for example, the map augmentation module 332 can cause useful map information to be included in a map of a vicinity of a location of the object. For example, the useful map information can include one or more of: (1) the one or more of: (a) the image that includes the representation of the object or (b) the other image that includes the representation of the object or (2) supplemental information. For example, the supplemental information can be based on one or more of: (a) information signified by the human-provided indication or (b) information produced concurrently with a production of the human-provided indication.

Additionally, at an operation 428, for example, the display presentation module 334 can cause the information about the object, produced in response to the query about the subject of the human-provided indication, to be presented on a display. For example, the display can be disposed on a vehicle.

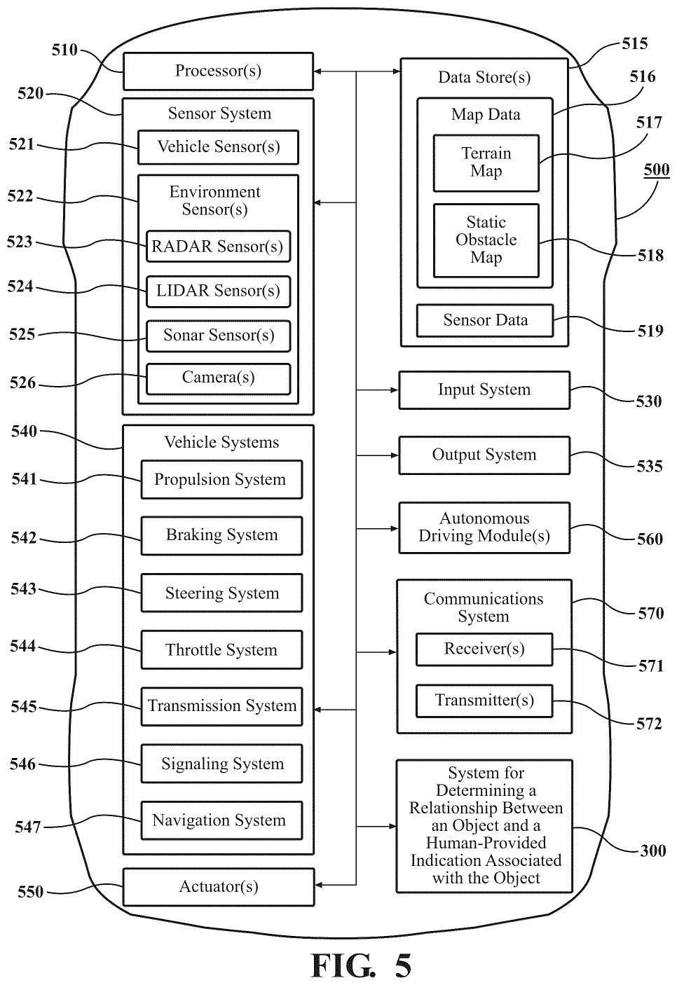

FIG. 5 includes a block diagram that illustrates an example of elements disposed on a vehicle 500, according to the disclosed technologies. As used herein, a “vehicle” can be any form of powered transport. In one or more implementations, the vehicle 500 can be an automobile. While arrangements described herein are with respect to automobiles, one of skill in the art understands, in light of the description herein, that embodiments are not limited to automobiles. For example, functions and/or operations of one or more of the second vehicle 118 (illustrated in FIGS. 1 and 2), the third vehicle 119 (illustrated in FIGS. 1 and 2), or the fourth vehicle 120 (illustrated in FIGS. 1 and 2) can be realized by the vehicle 500.

In some embodiments, the vehicle 500 can be configured to switch selectively between an automated mode, one or more semi-automated operational modes, and/or a manual mode. Such switching can be implemented in a suitable manner, now known or later developed. As used herein, “manual mode” can refer that all of or a majority of the navigation and/or maneuvering of the vehicle 500 is performed according to inputs received from a user (e.g., human driver). In one or more arrangements, the vehicle 500 can be a conventional vehicle that is configured to operate in only a manual mode.

In one or more embodiments, the vehicle 500 can be an automated vehicle. As used herein, “automated vehicle” can refer to a vehicle that operates in an automated mode. As used herein, “automated mode” can refer to navigating and/or maneuvering the vehicle 500 along a travel route using one or more computing systems to control the vehicle 500 with minimal or no input from a human driver. In one or more embodiments, the vehicle 500 can be highly automated or completely automated. In one embodiment, the vehicle 500 can be configured with one or more semi-automated operational modes in which one or more computing systems perform a portion of the navigation and/or maneuvering of the vehicle along a travel route, and a vehicle operator (i.e., driver) provides inputs to the vehicle 500 to perform a portion of the navigation and/or maneuvering of the vehicle 500 along a travel route.

For example, Standard J3016 202104, Taxonomy and Definitions for Terms Related to Driving Automation Systems for On-Road Motor Vehicles, issued by the Society of Automotive Engineers (SAE) International on Jan. 16, 2014, and most recently revised on Apr. 30, 2021, defines six levels of driving automation. These six levels include: (1) level 0, no automation, in which all aspects of dynamic driving tasks are performed by a human driver; (2) level 1, driver assistance, in which a driver assistance system, if selected, can execute, using information about the driving environment, either steering or acceleration/deceleration tasks, but all remaining driving dynamic tasks are performed by a human driver; (3) level 2, partial automation, in which one or more driver assistance systems, if selected, can execute, using information about the driving environment, both steering and acceleration/deceleration tasks, but all remaining driving dynamic tasks are performed by a human driver; (4) level 3, conditional automation, in which an automated driving system, if selected, can execute all aspects of dynamic driving tasks with an expectation that a human driver will respond appropriately to a request to intervene; (5) level 4, high automation, in which an automated driving system, if selected, can execute all aspects of dynamic driving tasks even if a human driver does not respond appropriately to a request to intervene; and (6) level 5, full automation, in which an automated driving system can execute all aspects of dynamic driving tasks under all roadway and environmental conditions that can be managed by a human driver.

The vehicle 500 can include various elements. The vehicle 500 can have any combination of the various elements illustrated in FIG. 5. In various embodiments, it may not be necessary for the vehicle 500 to include all of the elements illustrated in FIG. 5. Furthermore, the vehicle 500 can have elements in addition to those illustrated in FIG. 5. While the various elements are illustrated in FIG. 5 as being located within the vehicle 500, one or more of these elements can be located external to the vehicle 500. Furthermore, the elements illustrated may be physically separated by large distances. For example, as described, one or more components of the disclosed system can be implemented within the vehicle 500 while other components of the system can be implemented within a cloud-computing environment, as described below. For example, the elements can include one or more processors 510, one or more data stores 515, a sensor system 520, an input system 530, an output system 535, vehicle systems 540, one or more actuators 550, one or more automated driving modules 560, a communications system 570, and the system 300 for determining a relationship between an object and a human-provided indication associated with the object.

In one or more arrangements, the one or more processors 510 can be a main processor of the vehicle 500. For example, the one or more processors 510 can be an electronic control unit (ECU). For example, functions and/or operations of one or more of the processor 123 (illustrated in FIGS. 1 and 2), the processor 136 (illustrated in FIGS. 1 and 2), the processor 149 (illustrated in FIGS. 1 and 2), or the processor 302 (illustrated in FIG. 3) can be realized by the one or more processors 510.

The one or more data stores 515 can store, for example, one or more types of data. The one or more data stores 515 can include volatile memory and/or non-volatile memory. Examples of suitable memory for the one or more data stores 515 can include Random-Access Memory (RAM), flash memory, Read-Only Memory (ROM), Programmable Read-Only Memory (PROM), Erasable Programmable Read-Only Memory (EPROM), Electrically Erasable Programmable Read-Only Memory (EEPROM), registers, magnetic disks, optical disks, hard drives, any other suitable storage medium, or any combination thereof. The one or more data stores 515 can be a component of the one or more processors 510. Additionally or alternatively, the one or more data stores 515 can be operatively connected to the one or more processors 510 for use thereby. As used herein, “operatively connected” can include direct or indirect connections, including connections without direct physical contact. As used herein, a statement that a component can be “configured to” perform an operation can be understood to mean that the component requires no structural alterations, but merely needs to be placed into an operational state (e.g., be provided with electrical power, have an underlying operating system running, etc.) in order to perform the operation. For example, functions and/or operations of one or more of the memory 124 (illustrated in FIGS. 1 and 2), the data storage 125 (illustrated in FIGS. 1 and 2), the memory 137 (illustrated in FIGS. 1 and 2), the data storage 138 (illustrated in FIGS. 1 and 2), the memory 150 (illustrated in FIGS. 1 and 2), the data storage 151 (illustrated in FIGS. 1 and 2), the memory 304 (illustrated in FIG. 3), or the data storage 320 (illustrated in FIG. 3) can be realized by the one or more data stores 515.

In one or more arrangements, the one or more data stores 515 can store map data 516. The map data 516 can include maps of one or more geographic areas. In some instances, the map data 516 can include information or data on roads, traffic control devices, road markings, structures, features, and/or landmarks in the one or more geographic areas. The map data 516 can be in any suitable form. In some instances, the map data 516 can include aerial views of an arca. In some instances, the map data 516 can include ground views of an area, including 360-degree ground views. The map data 516 can include measurements, dimensions, distances, and/or information for one or more items included in the map data 516 and/or relative to other items included in the map data 516. The map data 516 can include a digital map with information about road geometry. The map data 516 can be high quality and/or highly detailed.

In one or more arrangements, the map data 516 can include one or more terrain maps 517. The one or more terrain maps 517 can include information about the ground, terrain, roads, surfaces, and/or other features of one or more geographic areas. The one or more terrain maps 517 can include elevation data of the one or more geographic areas. The map data 516 can be high quality and/or highly detailed. The one or more terrain maps 517 can define one or more ground surfaces, which can include paved roads, unpaved roads, land, and other things that define a ground surface.

In one or more arrangements, the map data 516 can include one or more static obstacle maps 518. The one or more static obstacle maps 518 can include information about one or more static obstacles located within one or more geographic areas. A “static obstacle” can be a physical object whose position does not change (or does not substantially change) over a period of time and/or whose size does not change (or does not substantially change) over a period of time. Examples of static obstacles can include trees, buildings, curbs, fences, railings, medians, utility poles, statues, monuments, signs, benches, furniture, mailboxes, large rocks, and hills. The static obstacles can be objects that extend above ground level. The one or more static obstacles included in the one or more static obstacle maps 518 can have location data, size data, dimension data, material data, and/or other data associated with them. The one or more static obstacle maps 518 can include measurements, dimensions, distances, and/or information for one or more static obstacles. The one or more static obstacle maps 518 can be high quality and/or highly detailed. The one or more static obstacle maps 518 can be updated to reflect changes within a mapped area.

In one or more arrangements, the one or more data stores 515 can store sensor data 519. As used herein, “sensor data” can refer to any information about the sensors with which the vehicle 500 can be equipped including the capabilities of and other information about such sensors. The sensor data 519 can relate to one or more sensors of the sensor system 520. For example, in one or more arrangements, the sensor data 519 can include information about one or more lidar sensors 524 of the sensor system 520.

In some arrangements, at least a portion of the map data 516 and/or the sensor data 519 can be located in one or more data stores 515 that are located onboard the vehicle 500. Additionally or alternatively, at least a portion of the map data 516 and/or the sensor data 519 can be located in one or more data stores 515 that are located remotely from the vehicle 500.

The sensor system 520 can include one or more sensors. As used herein, a “sensor” can refer to any device, component, and/or system that can detect and/or sense something. The one or more sensors can be configured to detect and/or sense in real-time. As used herein, the term “real-time” can refer to a level of processing responsiveness that is perceived by a user or system to be sufficiently immediate for a particular process or determination to be made, or that enables the processor to keep pace with some external process.

In arrangements in which the sensor system 520 includes a plurality of sensors, the sensors can work independently from each other. Alternatively, two or more of the sensors can work in combination with each other. In such a case, the two or more sensors can form a sensor network. The sensor system 520 and/or the one or more sensors can be operatively connected to the one or more processors 510, the one or more data stores 515, and/or another element of the vehicle 500 (including any of the elements illustrated in FIG. 5). The sensor system 520 can acquire data of at least a portion of the external environment of the vehicle 500 (e.g., nearby vehicles). The sensor system 520 can include any suitable type of sensor. Various examples of different types of sensors are described herein. However, one of skill in the art understands that the embodiments are not limited to the particular sensors described herein.

The sensor system 520 can include one or more vehicle sensors 521. The one or more vehicle sensors 521 can detect, determine, and/or sense information about the vehicle 500 itself. In one or more arrangements, the one or more vehicle sensors 521 can be configured to detect and/or sense position and orientation changes of the vehicle 500 such as, for example, based on inertial acceleration. In one or more arrangements, the one or more vehicle sensors 521 can include one or more accelerometers, one or more gyroscopes, an inertial measurement unit (IMU), a dead-reckoning system, a global navigation satellite system (GNSS), a global positioning system (GPS), a navigation system 547, and/or other suitable sensors. The one or more vehicle sensors 521 can be configured to detect and/or sense one or more characteristics of the vehicle 500. In one or more arrangements, the one or more vehicle sensors 521 can include a speedometer to determine a current speed of the vehicle 500.

Additionally or alternatively, the sensor system 520 can include one or more environment sensors 522 configured to acquire and/or sense driving environment data. As used herein, “driving environment data” can include data or information about the external environment in which a vehicle is located or one or more portions thereof. For example, the one or more environment sensors 522 can be configured to detect, quantify, and/or sense obstacles in at least a portion of the external environment of the vehicle 500 and/or information/data about such obstacles. Such obstacles may be stationary objects and/or dynamic objects. The one or more environment sensors 522 can be configured to detect, measure, quantify, and/or sense other things in the external environment of the vehicle 500 such as, for example, lane markers, signs, traffic lights, traffic signs, lane lines, crosswalks, curbs proximate the vehicle 500, off-road objects, etc. For example, functions and/or operations of the sensor 230 (illustrated in FIG. 2) can be realized by the one or more environment sensors 522.

Various examples of sensors of the sensor system 520 are described herein. The example sensors may be part of the one or more vehicle sensors 521 and/or the one or more environment sensors 522. However, one of skill in the art understands that the embodiments are not limited to the particular sensors described.

In one or more arrangements, the one or more environment sensors 522 can include one or more radar sensors 523, one or more lidar sensors 524, one or more sonar sensors 525, and/or one more cameras 526. In one or more arrangements, the one or more cameras 526 can be one or more high dynamic range (HDR) cameras or one or more infrared (IR) cameras. For example, the one or more cameras 526 can be used to record a reality of a state of an item of information that can appear in the digital map. For example, functions and/or operations of one or more of the forward-facing camera 127 (illustrated in FIGS. 1 and 2), the rearward-facing camera 128 (illustrated in FIGS. 1 and 2), the cabin view camera 129 (illustrated in FIGS. 1 and 2), the forward-facing camera 140 (illustrated in FIGS. 1 and 2), the rearward-facing camera 141 (illustrated in FIGS. 1 and 2), the cabin view camera 142 (illustrated in FIGS. 1 and 2), the forward-facing camera 153 (illustrated in FIGS. 1 and 2), the rearward-facing camera 154 (illustrated in FIGS. 1 and 2), or the cabin view camera 155 (illustrated in FIGS. 1 and 2) can be realized by the one or more cameras 526.

The input system 530 can include any device, component, system, element, arrangement, or groups thereof that enable information/data to be entered into a machine. The input system 530 can receive an input from a vehicle passenger (e.g., a driver or a passenger). The output system 535 can include any device, component, system, element, arrangement, or groups thereof that enable information/data to be presented to a vehicle passenger (e.g., a driver or a passenger). For example, functions and/or operations of one or more of the microphone 130 (illustrated in FIGS. 1 and 2), the microphone 143 (illustrated in FIGS. 1 and 2), or the microphone 156 (illustrated in FIGS. 1 and 2) can be realized by the input system 530. For example, functions and/or operations of one or more of the display 131 (illustrated in FIGS. 1 and 2), the display 144 (illustrated in FIGS. 1 and 2), or the display 157 (illustrated in FIGS. 1 and 2) can be realized by the output system 535.

Various examples of the one or more vehicle systems 540 are illustrated in FIG. 5. However, one of skill in the art understands that the vehicle 500 can include more, fewer, or different vehicle systems. Although particular vehicle systems can be separately defined, each or any of the systems or portions thereof may be otherwise combined or segregated via hardware and/or software within the vehicle 500. For example, the one or more vehicle systems 540 can include a propulsion system 541, a braking system 542, a steering system 543, a throttle system 544, a transmission system 545, a signaling system 546, and/or the navigation system 547. Each of these systems can include one or more devices, components, and/or a combination thereof, now known or later developed.

The navigation system 547 can include one or more devices, applications, and/or combinations thereof, now known or later developed, configured to determine the geographic location of the vehicle 500 and/or to determine a travel route for the vehicle 500. The navigation system 547 can include one or more mapping applications to determine a travel route for the vehicle 500. The navigation system 547 can include a global positioning system, a local positioning system, a geolocation system, and/or a combination thereof.

The one or more actuators 550 can be any element or combination of elements operable to modify, adjust, and/or alter one or more of the vehicle systems 540 or components thereof responsive to receiving signals or other inputs from the one or more processors 510 and/or the one or more automated driving modules 560. Any suitable actuator can be used. For example, the one or more actuators 550 can include motors, pneumatic actuators, hydraulic pistons, relays, solenoids, and/or piezoelectric actuators.

The one or more processors 510 and/or the one or more automated driving modules 560 can be operatively connected to communicate with the various vehicle systems 540 and/or individual components thereof. For example, the one or more processors 510 and/or the one or more automated driving modules 560 can be in communication to send and/or receive information from the various vehicle systems 540 to control the movement, speed, maneuvering, heading, direction, etc. of the vehicle 500. The one or more processors 510 and/or the one or more automated driving modules 560 may control some or all of these vehicle systems 540 and, thus, may be partially or fully automated.

The one or more processors 510 and/or the one or more automated driving modules 560 may be operable to control the navigation and/or maneuvering of the vehicle 500 by controlling one or more of the vehicle systems 540 and/or components thereof. For example, when operating in an automated mode, the one or more processors 510 and/or the one or more automated driving modules 560 can control the direction and/or speed of the vehicle 500. The one or more processors 510 and/or the one or more automated driving modules 560 can cause the vehicle 500 to accelerate (e.g., by increasing the supply of fuel provided to the engine), decelerate (e.g., by decreasing the supply of fuel to the engine and/or by applying brakes) and/or change direction (e.g., by turning the front two wheels). As used herein, “cause” or “causing” can mean to make, force, compel, direct, command, instruct, and/or enable an event or action to occur or at least be in a state where such event or action may occur, either in a direct or indirect manner.

The communications system 570 can include one or more receivers 571 and/or one or more transmitters 572. The communications system 570 can receive and transmit one or more messages through one or more wireless communications channels. For example, the one or more wireless communications channels can be in accordance with the Institute of Electrical and Electronics Engineers (IEEE) 802.11p standard to add wireless access in vehicular environments (WAVE) (the basis for Dedicated Short-Range Communications (DSRC)), the 3rd Generation Partnership Project (3GPP) Long-Term Evolution (LTE) Vehicle-to-Everything (V2X) (LTE-V2X) standard (including the LTE Uu interface between a mobile communication device and an Evolved Node B of the Universal Mobile Telecommunications System), the 3GPP fifth generation (5G) New Radio (NR) Vehicle-to-Everything (V2X) standard (including the 5G NR Uu interface), or the like. For example, the communications system 570 can include “connected vehicle” technology. “Connected vehicle” technology can include, for example, devices to exchange communications between a vehicle and other devices in a packet-switched network. Such other devices can include, for example, another vehicle (e.g., “Vehicle to Vehicle” (V2V) technology), roadside infrastructure (e.g., “Vehicle to Infrastructure” (V2I) technology), a cloud platform (e.g., “Vehicle to Cloud” (V2C) technology), a pedestrian (e.g., “Vehicle to Pedestrian” (V2P) technology), or a network (e.g., “Vehicle to Network” (V2N) technology. “Vehicle to Everything” (V2X) technology can integrate aspects of these individual communications technologies. For example, functions and/or operations of one or more of the communications device 126 (illustrated in FIGS. 1 and 2), the communications device 139 (illustrated in FIGS. 1 and 2), or the communications device 152 (illustrated in FIGS. 1 and 2) can be realized by the communications system 570.

Moreover, the one or more processors 510, the one or more data stores 515, and the communications system 570 can be configured to one or more of form a micro cloud, participate as a member of a micro cloud, or perform a function of a leader of a micro cloud. A micro cloud can be characterized by a distribution, among members of the micro cloud, of one or more of one or more computing resources or one or more data storage resources in order to collaborate on executing operations. The members can include at least connected vehicles.

The vehicle 500 can include one or more modules, at least some of which are described herein. The modules can be implemented as computer-readable program code that, when executed by the one or more processors 510, implement one or more of the various processes described herein. One or more of the modules can be a component of the one or more processors 510. Additionally or alternatively, one or more of the modules can be executed on and/or distributed among other processing systems to which the one or more processors 510 can be operatively connected. The modules can include instructions (e.g., program logic) executable by the one or more processors 510. Additionally or alternatively, the one or more data store 515 may contain such instructions.

In one or more arrangements, one or more of the modules described herein can include artificial or computational intelligence elements, e.g., neural network, fuzzy logic, or other machine learning algorithms. Further, in one or more arrangements, one or more of the modules can be distributed among a plurality of the modules described herein. In one or more arrangements, two or more of the modules described herein can be combined into a single module.

The vehicle 500 can include one or more automated driving modules 560. The one or more automated driving modules 560 can be configured to receive data from the sensor system 520 and/or any other type of system capable of capturing information relating to the vehicle 500 and/or the external environment of the vehicle 500. In one or more arrangements, the one or more automated driving modules 560 can use such data to generate one or more driving scene models. The one or more automated driving modules 560 can determine position and velocity of the vehicle 500. The one or more automated driving modules 560 can determine the location of obstacles, obstacles, or other environmental features including traffic signs, trees, shrubs, neighboring vehicles, pedestrians, etc.

The one or more automated driving modules 560 can be configured to receive and/or determine location information for obstacles within the external environment of the vehicle 500 for use by the one or more processors 510 and/or one or more of the modules described herein to estimate position and orientation of the vehicle 500, vehicle position in global coordinates based on signals from a plurality of satellites, or any other data and/or signals that could be used to determine the current state of the vehicle 500 or determine the position of the vehicle 500 with respect to its environment for use in either creating a map or determining the position of the vehicle 500 in respect to map data.

The one or more automated driving modules 560 can be configured to determine one or more travel paths, current automated driving maneuvers for the vehicle 500, future automated driving maneuvers and/or modifications to current automated driving maneuvers based on data acquired by the sensor system 520, driving scene models, and/or data from any other suitable source such as determinations from the sensor data 519. As used herein, “driving maneuver” can refer to one or more actions that affect the movement of a vehicle. Examples of driving maneuvers include: accelerating, decelerating, braking, turning, moving in a lateral direction of the vehicle 500, changing travel lanes, merging into a travel lane, and/or reversing, just to name a few possibilities. The one or more automated driving modules 560 can be configured to implement determined driving maneuvers. The one or more automated driving modules 560 can cause, directly or indirectly, such automated driving maneuvers to be implemented. As used herein, “cause” or “causing” means to make, command, instruct, and/or enable an event or action to occur or at least be in a state where such event or action may occur, either in a direct or indirect manner. The one or more automated driving modules 560 can be configured to execute various vehicle functions and/or to transmit data to, receive data from, interact with, and/or control the vehicle 500 or one or more systems thereof (e.g., one or more of vehicle systems 540). For example, functions and/or operations of an automotive navigation system can be realized by the one or more automated driving modules 560.

Detailed embodiments are disclosed herein. However, one of skill in the art understands, in light of the description herein, that the disclosed embodiments are intended only as examples. Therefore, specific structural and functional details disclosed herein are not to be interpreted as limiting, but merely as a basis for the claims and as a representative basis for teaching one of skill in the art to variously employ the aspects herein in virtually any appropriately detailed structure. Furthermore, the terms and phrases used herein are not intended to be limiting but rather to provide an understandable description of possible implementations. Various embodiments are illustrated in FIGS. 1-3, 4A, 4B, and 5, but the embodiments are not limited to the illustrated structure or application.

The flowchart and block diagrams in the figures illustrate the architecture, functionality, and operation of possible implementations of systems, methods, and computer program products according to various embodiments. In this regard, each block in flowcharts or block diagrams may represent a module, segment, or portion of code, which comprises one or more executable instructions for implementing the specified logical function(s). One of skill in the art understands, in light of the description herein, that, in some alternative implementations, the functions described in a block may occur out of the order depicted by the figures. For example, two blocks depicted in succession may, in fact, be executed substantially concurrently, or the blocks may be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suitable. A typical combination of hardware and software can be a processing system with computer-readable program code that, when loaded and executed, controls the processing system such that it carries out the methods described herein. The systems, components, and/or processes also can be embedded in a computer-readable storage, such as a computer program product or other data programs storage device, readable by a machine, tangibly embodying a program of instructions executable by the machine to perform methods and processes described herein. These elements also can be embedded in an application product that comprises all the features enabling the implementation of the methods described herein and that, when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. As used herein, the phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples of the computer-readable storage medium would include, in a non-exhaustive list, the following: a portable computer diskette, a hard disk drive (HDD), a solid-state drive (SSD), a read-only memory (ROM), an erasable programmable read-only memory (EPROM or flash memory), a portable compact disc read-only memory (CD-ROM), a digital versatile disc (DVD), an optical storage device, a magnetic storage device, or any suitable combination of the foregoing. As used herein, a computer-readable storage medium may be any tangible medium that can contain or store a program for use by or in connection with an instruction execution system, apparatus, or device.

Generally, modules, as used herein, include routines, programs, objects, components, data structures, and so on that perform particular tasks or implement particular data types. In further aspects, a memory generally stores such modules. The memory associated with a module may be a buffer or may be cache embedded within a processor, a random-access memory (RAM), a ROM, a flash memory, or another suitable electronic storage medium. In still further aspects, a module as used herein, may be implemented as an application-specific integrated circuit (ASIC), a hardware component of a system on a chip (SoC), a programmable logic array (PLA), or another suitable hardware component (e.g., a central processing unit (CPU), a graphics processing unit (GPU), a field-programmable gate array (FPGA), or the like) that is embedded with a defined configuration set (e.g., instructions) for performing the disclosed functions.

Program code embodied on a computer-readable medium may be transmitted using any appropriate medium, including but not limited to wireless, wireline, optical fiber, cable, radio frequency (RF), etc., or any suitable combination of the foregoing. Computer program code for carrying out operations for aspects of the disclosed technologies may be written in any combination of one or more programming languages, including an object-oriented programming language such as Java™, Smalltalk, C++, or the like, and conventional procedural programming languages such as the “C” programming language or similar programming languages. The program code may execute entirely on a user's computer, partly on a user's computer, as a stand-alone software package, partly on a user's computer and partly on a remote computer, or entirely on a remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . or . . . ” as used herein refers to and encompasses any and all possible combinations of one or more of the associated listed items. For example, the phrase “at least one of A, B, or C” includes A only, B only, C only, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

1. A system, comprising:
a processor; and
a memory storing:
an image reception module including instructions that, when executed by the processor, cause the processor to receive an image that includes a representation of an object, but lacks a representation of a human-provided indication associated with the object;
a recording reception module including instructions that, when executed by the processor, cause the processor to receive a recording that includes the representation of the human-provided indication, but lacks the representation of the object;
a relationship determination module including instructions that, when executed by the processor, cause the processor to determine, based on:
information about a location of the object at a first time, the first time being when the image was produced by a camera, and
information about a relative motion between the camera and the object between the first time and a second time, the second time being when the recording was produced,
an existence of a relationship between the object and the human-provided indication;
a database relationship establishment module including instructions that, when executed by the processor, cause the processor to cause, without a need to use textual information, information about the existence of the relationship to be stored in a database; and
a database query module including instructions that, when executed by the processor, cause the processor to cause, based on the existence of the relationship, the database to produce, in response to a query about a subject of the human-provided indication, information about the object.

2. The system of claim 1, wherein at least one of:
the recording is a recording of sound, or
the image is a first image and the recording is a second image.

3. The system of claim 2, wherein:
the camera is a first camera, and
the second image was produced by a second camera.

4. The system of claim 3, wherein:
the first camera is at least one of:
a forward-facing camera disposed on a vehicle, or
a rearward-facing camera disposed on the vehicle, and
the second camera is a cabin view camera disposed on the vehicle.

5. The system of claim 1, wherein the human-provided indication comprises at least one of:
a hand gesture,
a gaze, or
an audible comment.

6. The system of claim 5, wherein at least one of:
the hand gesture is a gesture to point in a specific direction,
the gaze is in the specific direction, or
the audible comment includes information that signifies the specific direction.

7. The system of claim 5, wherein at least one of:
the hand gesture signifies an opinion of a human that produced the hand gesture,
the gaze signifies an opinion of a human that produced the gaze, or
the audible comment signifies an opinion of a human that produced the audible comment.

8. The system of claim 1, wherein:
the human-provided indication signifies a specific direction,
a location of the object at the second time is in the specific direction from a human that produced the human-provided indication, and
the instructions to determine the existence of the relationship include instructions to determine that the location of the object at the first time corresponds to the representation of the object included in the image.

9. The system of claim 8, wherein the memory further stores at least one of:
a hand gesture module including instructions that, when executed by the processor, cause the processor to cause, in response to the human-provided indication including a hand gesture, an operation of a hand gesture technique, the hand gesture technique including:
operating gesture recognition technology to determine that the hand gesture is a gesture to point in the specific direction, and
producing a hand gesture vector in the specific direction, an origin of the hand gesture vector being a hand arranged to produce the hand gesture, or
a gaze module including instructions that, when executed by the processor, cause the processor to cause, in response to the human-provided indication including a gaze, an operation of a gaze technique, the gaze technique including:
operating eye point-of-gaze tracking technology to determine that a point of gaze of an eye is in the specific direction, and
producing a gaze vector in the specific direction, an origin of the gaze vector being the eye.

10. The system of claim 1, wherein the relationship information includes:
the recording that includes the representation of the human-provided indication, and
at least one of the image that includes the representation of the object or another image that includes the representation of the object.

11. The system of claim 10, wherein the memory further stores an image annotation module including instructions that, when executed by the processor, cause the processor to cause the at least one of the image that includes the representation of the object or the other image that includes the representation of the object to be annotated with supplemental information, the supplemental information being based on at least one of information signified by the human-provided indication or information produced concurrently with a production of the human-provided indication.

12. The system of claim 10, wherein the memory further stores an object recognition and classification module including instructions that, when executed by the processor, cause the processor to cause the object to be recognized and classified.

13. The system of claim 10, wherein the memory further stores an image transformation module including instructions that, when executed by the processor, cause the processor to produce, based on the image that includes the representation of the object, the other image that includes the representation of the object, the other image being a transformation of the image.

14. The system of claim 10, wherein:
the image that includes the representation of the object is a member of a set of images that include the representation of the object, and
the memory further stores:
an image quality measurement module including instructions that, when executed by the processor, cause the processor to determine an image, of the set of images, in which a measurement of an image quality of the object is a greatest value; and
an image designation module including instructions that, when executed by the processor, cause the processor to designate the image, of the set of images, in which the measurement of the image quality of the object is the greatest value, as the other image that includes the representation of the object.

15. The system of claim 10, wherein the memory further stores a map augmentation module including instructions that, when executed by the processor, cause the processor to cause useful map information to be included in a map of a vicinity of a location of the object, the useful map information including at least one of:
the at least one of the image that includes the representation of the object or the other image that includes the representation of the object, or
supplemental information, the supplemental information being based on at least one of information signified by the human-provided indication or information produced concurrently with a production of the human-provided indication.

16. A method, comprising:
receiving, by a processor, an image that includes a representation of an object, but lacks a representation of a human-provided indication associated with the object;
receiving, by a processor, a recording that includes the representation of the human-provided indication, but lacks the representation of the object;
determining, by the processor and based on:
information about a location of the object at a first time, the first time being when the image was produced by a camera, and
information about a relative motion between the camera and the object between the first time and a second time, the second time being when the recording was produced,
an existence of a relationship between the object and the human-provided indication;
causing, by the processor and without a need to use textual information, information about the relationship to be stored in a database configured to operate a database technology; and
causing, by the processor and based on the existence, a relationship, the database to produce, in response to a query about a subject of the human-provided indication, information about the object.

17. (canceled)

18. The method of claim 16, wherein the second time is after the first time.

19. The method of claim 16, wherein the second time is before the first time.

20. A non-transitory computer-readable medium for determining a relationship between an object and a human-provided indication associated with the object, the non-transitory computer-readable medium including instructions that, when executed by one or more processors, cause the one or more processors to:
receive an image that includes a representation of the object, but lacks a representation of the human-provided indication associated with the object;
receive a recording that includes the representation of the human-provided indication, but lacks the representation of the object;
determine, based on:
information about a location of the object at a first time, the first time being when the image was produced by a camera, and
information about a relative motion between the camera and the object between the first time and a second time, the second time being when the recording was produced,
an existence of the relationship between the object and the human-provided indication;
cause, without a need to use textual information, information about the relationship to be stored in a database configured to operate a database technology; and
cause, based on the relationship, the database to produce, in response to a query about a subject of the human-provided indication, information about the object.

21. The system of claim 1, wherein the object is outside of a field of view of the camera at the second time.
